(19) United States
(12) Patent Application Publication
(10) Pub. No.: US 2018/0101595 A1
(43) Pub. Date: Apr. 12, 2018

(54) MESSAGE MANAGEMENT IN A SOCIAL NETWORKING ENVIRONMENT

(71) Applicant: International Business Machines Corporation, Armonk, NY (US)

(72) Inventors: Paul R. Bastide, Boxford, MA (US); Matthew E. Broomhall, Goffstown, NH (US); Thomas J. Evans, IV, Cary, NC (US); Robert E. Loredo, North Miami Beach, FL (US)

(21) Appl. No.: 15/854,022

(22) Filed: Dec. 26, 2017

Related U.S. Application Data
(63) Continuation of application No. 15/289,895, filed on Oct. 10, 2016.

(51) Int. Cl. G06F 17/30; H04L 12/58; G06F 17/27

(52) U.S. Cl. CPC G06F 17/30598; H04L 51/32; G06F 17/30477; G06F 17/274; G06F 17/30283; G06F 17/3053

(57) ABSTRACT

Disclosed aspects relate to message management utilizing a social networking environment. A set of message data may be detected in the social networking environment. A set of dynamic event data related to a dynamic event may be ingested. A set of inference data related to the dynamic event may be resolved using the set of dynamic event data related to the dynamic event. A corroboration relationship with respect to the set of message data and the set of inference data may be determined by correlating the set of message data with the set of inference data. Based on the corroboration relationship, a corroborated message related to the dynamic event may be compiled.

### BACKGROUND

This disclosure relates generally to computer systems and, more particularly, relates to message management utilizing a social networking environment. Social network environments may be used to facilitate message transmission and communication between users. The amount of information communicated using social networking environments is increasing. As the amount of information communicated using social networking environments increases, the need for message management may also increase.

### SUMMARY

Aspects of the disclosure relate to message management utilizing a social networking environment. Messages that are contextually relevant to a particular event may be identified and substantiated to promote content reliability. One or more live events may be identified and analyzed to collect data related to the live event. Based on the collected data, a set of inferences pertaining to the live event may be generated. In response to detecting a user-generated message, the set of inferences generated for the live event may be validated and correlated with the user-generated message. The user-generated message may be augmented based on the correlated inferences generated for the live event.

Disclosed aspects relate to message management utilizing a social networking environment. A set of message data may be detected in the social networking environment. A set of dynamic event data related to a dynamic event may be ingested. A set of inference data related to the dynamic event may be resolved using the set of dynamic event data related to the dynamic event. A corroboration relationship with respect to the set of message data and the set of inference data may be determined by correlating the set of message data with the set of inference data. Based on the corroboration relationship, a corroborated message related to the dynamic event may be compiled.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level block diagram of a computer system for implementing various embodiments of the present disclosure, according to embodiments.

FIG. 2 is a flowchart illustrating a method of message management utilizing a social networking environment, according to embodiments.

FIG. 3 shows an example system for message management utilizing a social networking environment, according to embodiments.

FIG. 4 shows an example architecture for message management, according to embodiments.

FIG. 5 illustrates an example corroborated message, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to message management utilizing a social networking environment. Messages that are contextually relevant to a particular event may be identified and substantiated to promote content reliability. One or more live events (e.g., sporting events, debates, concerts, news events) may be identified and analyzed to collect data related to the live event (e.g., closed captions, media clips, object recognition). Based on the collected data, a set of inferences pertaining to the live event may be generated. In response to detecting a user-generated message (e.g., using a social networking environment) the set of inferences generated for the live event may be validated and correlated with the user-generated message. The user-generated message may be augmented based on the correlated inferences generated for the live event. Leveraging a set of inferences for a live event with respect to user-generated messages may be associated with content relevance, context awareness, and communication reliability.

Online social networks are one tool for connecting people, sharing information, and promoting communication between users. In recent years, the amount of messages handled by social networks has grown exponentially. Aspects of the disclosure relate to the recognition that, with the rise in social network use, finding social media content that is contextually relevant to a particular event or topic may prove challenging, as social media interfaces (e.g., activity streams) are crowded with potentially irrelevant messages or outdated content. Accordingly, aspects of the disclosure relate to identifying social media messages that are associated with a particular event (e.g., sporting event, concert, parade, news event), and correlating the social media messages with data related to the event itself (e.g., pictures, videos, inferences drawn from the event). Coupling social media messages together with contextually relevant content may be associated with content reliability (e.g., the event data may be used to substantiate, corroborate, or otherwise verify the authenticity of the social media message or vice versa).

Aspects of the disclosure include a system, method, and computer program product for message management utilizing a social networking environment. A set of message data may be detected in the social networking environment. In embodiments, a set of dynamic event data related to a dynamic event may be monitored. A set of dynamic event data related to the dynamic event may be ingested. The set of dynamic event data may include audio data, video data, still image data, textual data, chat data, web conference data, streaming data, and the like. In embodiments, a set of data objects may be captured using the set of dynamic event data related to the dynamic event. The set of data objects may be analyzed to resolve a set of inference data related to the dynamic event. Accordingly, a set of inference data related to the dynamic event may be resolved using the set of dynamic event data related to the dynamic event.

A corroboration relationship with respect to the set of message data and the set of inference data may be determined by correlating the set of message data with the set of inference data. Based on the corroboration relationship with respect to the set of message data and the set of inference data, a corroborated message related to the dynamic event may be compiled. In embodiments, the set of message data may be augmented using the set of inference data to compile the corroborated message. In embodiments, augmenting the set of message data using the set of inference data may benefit a content reliability score for the corroborated message. Altogether, aspects of the disclosure can have performance or efficiency benefits (e.g., reliability, speed, flexibility, responsiveness, stability, high availability, resource usage, productivity). Aspects may save resources such as bandwidth, disk, processing, or memory.

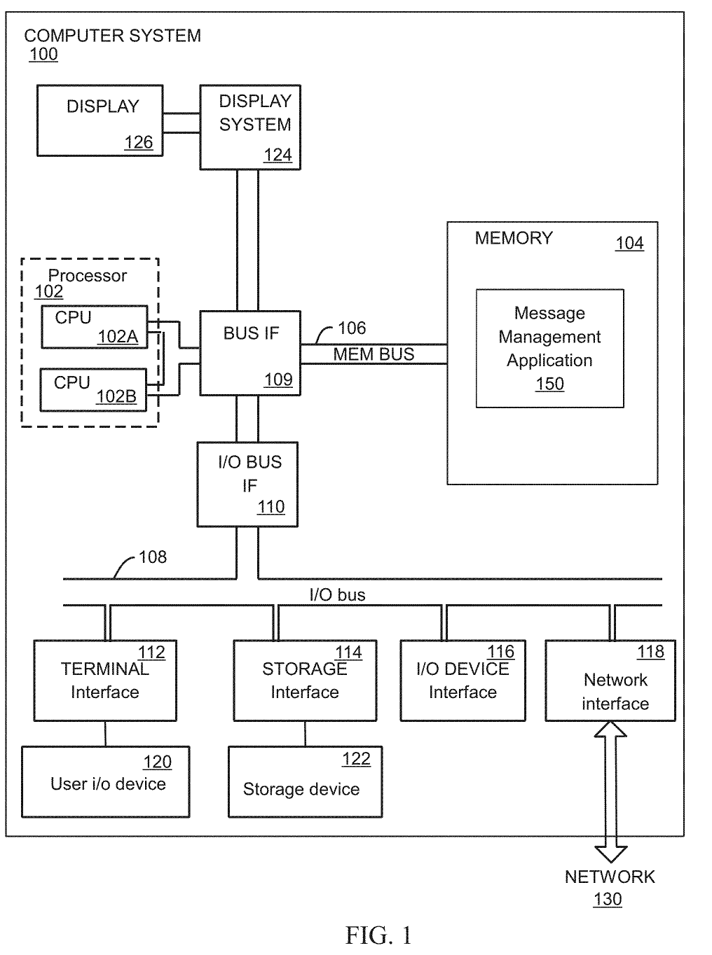

Turning now to the figures, FIG. 1 depicts a high-level block diagram of a computer system for implementing various embodiments of the present disclosure, according to embodiments. The mechanisms and apparatus of the various embodiments disclosed herein apply equally to any appropriate computing system. The major components of the computer system 100 include one or more processors 102, a memory 104, a terminal interface 112, a storage interface 114, an I/O (Input/Output) device interface 116, and a network interface 118, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a message management application 150. In embodiments, the message management application 150 may include instructions or statements that execute on the processor 102 or instructions or statements that are interpreted by instructions or statements that execute on the processor 102 to carry out the functions as further described below. In certain embodiments, the message management application 150 is implemented in hardware via semiconductor devices, chips, logical gates, circuits, circuit cards, and/or other physical hardware devices in lieu of, or in addition to, a processor-based system. In embodiments, the message management application 150 may include data in addition to instructions or statements.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 114, 116, and 118, which are also known as I/O processors (IOPs) or I/O adapters (IOAs), through the I/O bus 108. The display system 124 may include a display controller, a display memory, or both. The display controller may provide video, audio, or both types of data to a display device 126. The display memory may be a dedicated memory for buffering video data. The display system 124 may be coupled with a display device 126, such as a standalone display screen, computer monitor, television, or a tablet or handheld device display. In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 120, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 120 and the computer system 100, and may receive output data via the user output devices. For example, a user interface may be presented via the user I/O device 120, such as displayed on a display device, played via a speaker, or printed via a printer.

The storage interface 114 supports the attachment of one or more disk drives or direct access storage devices 122 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 122 may be implemented via any type of secondary storage device. The contents of the memory 104, or any portion thereof, may be stored to and retrieved from the storage device 122 as needed. The I/O device interface 116 provides an interface to any of various other I/O devices or devices of other types, such as printers or fax machines. The network interface 118 provides one or more communication paths from the computer system 100 to other digital devices and computer systems; these communication paths may include, e.g., one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown, which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

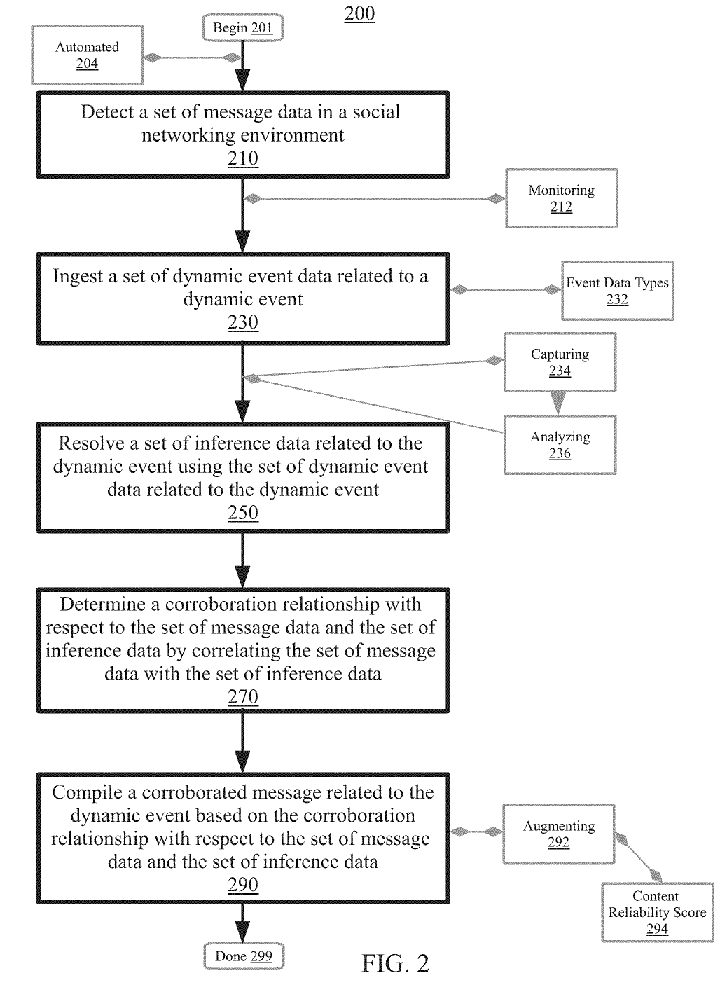

FIG. 2 is a flowchart illustrating a method 200 of message management utilizing a social networking environment. Aspects of FIG. 2 relate to correlating a set of inferences derived from a dynamic event with a user-generated message to compile a corroborated message related to the dynamic event. The dynamic event may include an occurrence, incident, episode, or happening that may be associated with a particular time, location, or context. The dynamic event may occur in real-time (e.g., live event, live broadcast). The dynamic event may include a past event for which media data (e.g., video, articles, sound files, images) may be archived. As examples, the dynamic event may include a sporting event, debate, parade, concert, news event, competition, or the like. Aspects of the disclosure relate to the recognition that, in embodiments, the dynamic event may be discussed on one or more social networking environments, such that data pertaining to the dynamic event may be generated and exchanged by users of social networking environments. Generally, social networking environments can include platforms that offer communication tools to facilitate the sharing of information, ideas, pictures, video, messages, and other data between a community of users. As examples, social networking environments may include one or more of instant messaging platforms (e.g., chat service), short messaging services (e.g., text messaging), wikis (e.g., user maintained digital encyclopedias), social communities (e.g., micro-blog, professional connections, photo-sharing, other groups of users), newsfeeds (e.g., interface for reception and display news events and activity data), email platforms (e.g., internet or other network-based messaging tool), calendars (e.g., shared calendar platform), product reviews (e.g., collection of user reviews), project collaborations (e.g., group of users working together on a task), or the like. Leveraging a set of inferences for the dynamic event with respect to user-generated messages may be associated with content relevance, context awareness, and communication reliability. The method 200 may begin at block 201.

In embodiments, the detecting, the ingesting, the resolving, the determining, the compiling, and other steps described herein may each occur in an automated fashion without user intervention at block 204. In embodiments, the detecting, the ingesting, the resolving, the determining, the compiling, and other steps described herein may be carried out by an internal message management module maintained in a persistent storage device of a local computing device (e.g., mobile computing device of a user). In certain embodiments, the detecting, the ingesting, the resolving, the determining, the compiling, and other steps described herein may be carried out by an external message management module hosted by a remote computing device or server (e.g., social network environment accessible via a subscription, usage-based, or other service model). In this way, aspects of message management may be performed using automated computing machinery without manual action. Other methods of performing the steps described herein are also possible.

At block 210, a set of message data may be detected in a social networking environment. Generally, detecting can include sensing, recognizing, discovering, identifying, ascertaining, or otherwise determining the set of message data. The set of message data can include communications, notes, conversations, or other information conveyed by individuals or organizations. As examples, the set of message data may include posts or replies submitted by users on public message boards, comments posted in discussion threads, status information, or other types of communication. The set of message data may include both substantive content (e.g., text, image, audio, video, or other media that comprises the body of the message data) as well as metadata (e.g., descriptive information such as the time, date, submitted location). As described herein, aspects of the disclosure relate to detecting the set of message data in a social networking environment. Detecting may include receiving submission of the set of message data to a social networking environment (e.g., by a user). For instance, a user may compose a textual message and submit it to be displayed publicly on his/her user profile page. Accordingly, the social networking environment may sense the submission of the user and identify the set of message data. In embodiments, detecting may include using a data structure analysis tool to parse a collection of existing (e.g., archived, previously submitted) social networking data, and identifying the set of message data. Other methods of detecting the set of message data are also possible.

Consider the following example. A user may initiate a social networking application maintained in memory on a personal mobile computing device. The user may compose a message of “Looking forward to the Porpoise game tonight-hopefully they can clinch a win to end the season!” and submit it to his/her personal user profile page on the social networking environment. In response to submission, both substantive content as well as metadata for the message may be detected. For instance, substantive content including the textual body of the message together with metadata including a time stamp of when the message was submitted (e.g., October 19th, 5:41 PM), the geographic location from where the message was submitted (e.g., based on internet protocol address, user-location services), and other information may be identified. In embodiments, detecting may include identifying a related topic or event referenced by the message. As an example, an associated dynamic event of “Sporting Event-October 19th Porpoise Football Game” may be identified for the detected message. Other methods of detecting the set of message data are also possible.

In embodiments, a set of dynamic event data related to a dynamic event may be monitored at block 212. Generally, monitoring can include observing, auditing, overseeing, supervising, or otherwise scanning for the set of dynamic event data. For instance, monitoring can include querying (e.g., asking a question), searching (e.g., exploring for a reason), obtaining (e.g., recording a collection), probing (e.g., checking a property), or tracking (e.g., following a characteristic.) In embodiments, the set of dynamic event data can include information or media that relates to, expresses, or otherwise characterizes a particular dynamic event. In embodiments, the set of dynamic event data may include a portion of media data (e.g., video clip, audio recording, still image) that represents one or more aspects of the dynamic event. In embodiments, monitoring may include scanning a set of media content (e.g., television broadcast, radio broadcast, internet video stream) and identifying portions of the media content that achieve a set of germaneness criteria (e.g., benchmarks or thresholds to assess relevancy). As an example, in certain embodiments, monitoring the set of dynamic event data may include scanning a video broadcast for portions of video content that include a specified individual (e.g., celebrity), group of individuals (e.g., sports team), or location (e.g., city), relate to a particular topic or theme (e.g., beekeeping), or demonstrate a particular quality (e.g., video of a certain resolution or higher). Other methods of monitoring for the set of dynamic event data related to the dynamic event are also possible.

At block 230, a set of dynamic event data related to a dynamic event may be ingested. Generally, ingesting can include detecting, importing, collecting, taking-in, processing, or otherwise receiving the set of dynamic event data. As described herein, the set of dynamic event data may can include information or media that relates to, expresses, or otherwise characterizes a particular dynamic event. As examples, the set of dynamic event data may include audio data (e.g., sound recording), video data (e.g., television broadcast, internet stream), still image data (e.g., photographs, pictures, computer generated graphics, images), textual data (e.g., closed captions, subtitles, transcripts), chat data (e.g., instant message logs, user comments), web conference data (e.g., electronic meeting audio and video logs), and streaming data (e.g., podcasts, internet live-streams) at block 232. For instance, the set of dynamic event data may include a video recording of a sporting event. In embodiments, ingesting may include using one or more sensor devices (e.g., camera, video camera, audio recorder) to capture the set of dynamic event data. For instance, ingesting the set of dynamic event data may include an individual using a camera to take a picture of parade. As another example, ingesting may include utilizing a mobile computing device (e.g., tablet, smartphone) to record a video of a concert. In embodiments, ingesting may include utilizing one or more content analysis techniques (e.g., digital image analysis, natural language processing, semantic audio parsing) to extract the set of dynamic event data from a collection of media content. For instance, ingesting may include applying a set of content analysis techniques to analyze a news broadcast and extracting a video clip related to a political speech. Other methods of ingesting the set of dynamic event data related to the dynamic event are also possible.

In embodiments, a set of data objects may be captured using the set of dynamic event data related to the dynamic event at block 234. Generally, capturing can include collecting, obtaining, acquiring, or ascertaining the set of data objects. The set of data objects may include portions, excerpts, attributes, or other aspects of the set of dynamic event data. For instance, the set of data objects may include screenshots (e.g., from a video stream) or media clips (e.g., excerpts of a television broadcast). In embodiments, capturing the set of data objects may include selecting a segment of the set of dynamic event data and extracting it (e.g., for analysis). As described herein, aspects of the disclosure relate to using the set of data objects captured from the set of dynamic event data to make one or more inferences (e.g., deductions, determinations) related to the dynamic event. In embodiments, the set of data objects may be analyzed to resolve a set of inference data related to the dynamic event at block 236. Generally, analyzing can include evaluating the content of the set of data objects to determine one or more properties, attributes, or characteristics (e.g., topic, theme, individuals, locations) of the dynamic event. Analyzing can include examining (e.g., performing an inspection of the set of data objects), evaluating (e.g., generating an appraisal of the set of data objects), resolving (e.g., ascertaining an observation/conclusion/answer with respect to the set of data objects), parsing (e.g., deciphering structured and unstructured data constructs of the set of data objects), querying (e.g., asking a question regarding the set of data objects) or categorizing (e.g., organizing by a feature or element of the set of data objects). As an example, analyzing may include using object recognition techniques and natural language processing techniques to ascertain visual and linguistic aspects of data objects that provide information about the context of the dynamic event (e.g., particular individuals present in the set of data objects, nature of the dynamic event). Other methods of analyzing the set of data objects are also possible.

Consider the following example. A particular geographic area may host a yearly summer festival (e.g., a dynamic event) in which crowds of people gather to see one or more exhibits, shows, competitions, concerts, and other events. For example, the summer festival may include a country music concert, a dog show, and a horse race. As described herein, aspects of the disclosure relate to ingesting a set of dynamic event data related to the dynamic event (e.g., the summer festival). Accordingly, in embodiments, a set of dynamic event data related to different aspects of the summer festival may be captured. For instance, ingesting may include an attendant to the dog show using a camera to take pictures of the different entrants, and uploading the images to an online photo gallery. In embodiments, ingesting may include analyzing video footage of the horse race recorded by a local news station, and identifying a set of highlights (e.g., particular horse pulling out in front of the pack, last 10 seconds of footage showing the conclusion of the race, award ceremony). The set of dynamic event data (e.g., pictures from the dog show and video highlights of the horse race) may be collected and stored in a central archive for the dynamic event. As described herein, a set of data objects may be captured from the set of dynamic event data and analyzed to resolve a set of inferences related to the dynamic event. For instance, the set of pictures from the dog show may be analyzed to determine the number of entrants and number of different dog breeds represented. As another example, the set of highlights identified from the horse race may be analyzed, and the final placing/ranking of the horses may be determined. Other methods of ingesting, capturing, and analyzing the set of dynamic event data are also possible.

At block 250, a set of inference data related to the dynamic event may be resolved. The set of inference data related to the dynamic event may be resolved using the set of dynamic event data related to the dynamic event. Generally, resolving can include ascertaining, identifying, deriving, extracting, or otherwise determining the set of inference data related to the dynamic event. The set of inference data may include one or more deductions, assumptions, interpretations, or conclusions derived from the set of dynamic event data. In embodiments, the set of inference data may include extracted inferences (e.g., portions of data or information taken directly from the set of dynamic event data) or abstracted inferences (e.g., conclusions drawn from evidence included in the set of dynamic event data) that characterize the context of the dynamic event. For instance, resolving the set of inference data may include using the set of dynamic event data to make an observation about a dynamic event (e.g., over 90% of the license plates of cars involved in a parade are from Minnesota), and applying abductive reasoning techniques to generate a possible explanation of the observation (e.g., the site of the parade is in Minnesota). In embodiments, resolving the set of inference data may include identifying one or more premises (e.g., statement, hypothesis) expressed in the set of dynamic event data (e.g., a new toy is wildly popular among consumers at launch events nationwide; the new toy is facing supply issues as manufacturing cannot maintain pace) and combining the premise(s) with one or more rules or principles stored in a knowledge database (e.g., high demand and low supply may lead to high prices) to generate a conclusion (e.g., the price of the new toy may increase). Other examples of resolving the set of inference data are also possible.

Consider the following example. A dynamic event in the form of a car chase may be in progress. A set of dynamic event data related to the dynamic event may be ingested. For instance, live aerial footage of the car chase may be recorded (e.g., via helicopter cameras) and live-streamed on one or more television stations, radio stations, and internet websites. As described herein, aspects of the disclosure relate to analyzing the set of dynamic event data to resolve a set of inference data related to the dynamic event. In embodiments, resolving the set of inference data may include extracting a caption from the live stream or a statement of a news caster commentating on the car chase in real-time. For instance, a caption from the live stream of “Bank Robber Getaway!” may be captured and analyzed to generate a set of inference data that indicates that the escapee in the car chase event may be armed (e.g., statistically, bank robberies are typically performed by armed assailants). As another example, a news caster's comment of “It appears that he may be taking 84th Street to the Interstate,” may be captured and analyzed to generate a set of inference data that indicates that drivers on Freemont Avenue (e.g., a road which intersects with 84th Street) should proceed with caution. Other types and methods of resolving the set of inference data are also possible.

At block 270, a corroboration relationship with respect to the set of message data and the set of inference data may be determined. The corroboration relationship may be determined by correlating the set of message data with the set of inference data. Generally, determining can include computing, formulating, generating, or otherwise ascertaining the corroboration relationship with respect to the set of message data and the set of inference data. Aspects of the disclosure relate to the recognition that, in some situations, establishing a link between a set of message data (e.g., social networking post) and a set of inference data (e.g., evidence or conclusion) derived from data for a live event may be associated with content reliability (e.g., the set of inference data may be used to verify the content of the set of message data or vice-versa). The corroboration relationship may include a link, connection, or other association between the set of inference data and the set of message data that serves to substantiate, validate, authenticate, or otherwise confirm the veracity of the set of inference data, the set of message data, or both. As described herein, determining the corroboration relationship may include correlating the set of message data with the set of inference data. In embodiments, correlating may include mapping the set of inference data to the set of message data (e.g., linking evidence or a conclusion drawn from the set of dynamic event data to authenticate the set of message data) or mapping the set of message data to the set of inference data (e.g., using an expert/verified source's statement to corroborate an inference). As an example, at a press event, a politician may claim that he has pursued a certain type of environment protection legislation for the past 15 years. Accordingly, the testimony of an independent commentator citing particular environmental protection bills may be correlated with the statement of the politician to determine the corroboration relationship. Other methods of determining the corroboration relationship are also possible.

Consider the following example. A dynamic event in the form of a new product announcement event held by a multinational technology company may be in progress. A set of dynamic event data including audio/video footage as well as textual commentary for the new product announcement event may be captured and broadcast on an internet live-stream feed. At the new product announcement event, the CEO of the technology company may claim that “Leveraging the new system architecture will allow for processing speeds that are 40% faster than architecture in use by the competition.” In response to the claim of the CEO, viewers of the new product announcement may submit social network messages attempting to interpret the meaning and implications of the CEO's claim (e.g., “Which competitor's architecture? Company A, B, or C?” “40% gains in processing speed may adversely affect battery life,” “Performance gains of that level might indicate a much higher price tag.”) In embodiments, as described herein, aspects of the disclosure relate to resolving a set of inference data related to the dynamic event. For example, the set of dynamic event data may be analyzed, and a set of inference data may be determined (e.g., based on previous presentation slides, architecture specifications) that indicates that the system architecture utilized by the new product is configured to make use of cloud computing techniques to reduce the processing load on the device itself (e.g., allowing for boosts to processing power without affecting battery life or price). In embodiments, a set of message data from an independent hardware analyst substantiating the claim of the CEO may be detected and correlated with the set of inference data to determine the corroboration relationship. Other methods of determining the corroboration relationship are also possible.

At block 290, a corroborated message related to the dynamic event may be compiled. The corroborated message may be compiled based on the corroboration relationship with respect to the set of message data and the set of inference data. Generally, compiling can include generating, arranging, assembling, creating, organizing, or otherwise composing the corroborated message. The corroborated message may include posts, replies, conversation threads, or other communications that have been substantiated, validated, or otherwise verified for authenticity or accuracy. In embodiments, the corroborated message may include an originally submitted social network message that has been edited to include a reference or supplement (e.g., set of inference data in the form of an image, video clip) to corroborate the content of the original message. In embodiments, the corroborated message may include a portion or excerpt of the set of dynamic event data (e.g., video clip, text transcript) that has been annotated with a message (e.g., from an expert or credible source) to confirm the veracity of the content. In certain embodiments, compiling the corroborated message may include marking a message (e.g., social network communication) with a tag, symbol, or other indicator that the contents of the message have been verified to be authentic. As an example, a social network communication that includes the message “At his book signing, fantasy author X. Y. Z. Jamison announced his new book will be made into a mini-series!” may be marked with a verification tag that authenticates the contents of the message (e.g., verification by the author, publication company, miniseries production company). Other methods of compiling the corroborated message related to the dynamic event are also possible.

In embodiments, the set of message data may be augmented using the set of inference data to compile the corroborated message at block 292. Augmenting may be performed in the social networking environment based on correlating the set of message data with the set of inference data. Generally, augmenting can include adding, appending, attaching, or supplementing, the set of message data with the set of inference data. As described herein, aspects of the disclosure relate to the recognition that appending a set of inference data (e.g., resolved based on dynamic event) to the set of message data may be used to corroborate or substantiate the contents of the set of message data. In embodiments, augmenting may include attaching a component (e.g., portion, piece, derived aspect) of the set of inference data to the set of message data. For instance, augmenting may include appending a data object (e.g., media clip) of the set of inference data to the set of message data. As an example, consider a situation in which a social network communication includes the message “The Porpoises managed to win the game 23-20!” In embodiments, augmenting may include attaching a picture of the final scoreboard to the social network communication (e.g., to substantiate the contents of the message). Other methods of augmenting the set of message data using the set of inference data are also possible.

In embodiments, augmenting the set of message data using the set of inference data may benefit a content reliability score for the corroborated message at block 294. As described herein, aspects of the disclosure relate to the recognition that augmenting a set of message data with a source, evidence, or other verification information (e.g., derived from the set of inference data) may be associated with content reliability. Accordingly, a content reliability score of the corroborated message may be benefited (e.g., positively impacted) by augmenting the set of message data with the set of inference data. Generally, the content reliability score can include a quantitative measure, representation, or indication of the authenticity, validity, accuracy, or dependability of the set of message data. For instance, the content reliability score may be expressed as an integer between 0 and 100, where greater values indicate greater reliability and lesser values indicate lesser reliability. As an example, consider a set of message data that includes the claim “Country music artist Flint Filmore fell off the stage at the concert tonight!” In embodiments, the set of message data may be initially associated with a content reliability score of 31 (e.g., the event has not been verified by any news stations or other testimonies). Accordingly, in response to appending a video (e.g., recorded using a smartphone of an attendee at the concert) of the country music artist falling off the stage, the content reliability score of the set of message data may increase from 31 to 86 (e.g., video evidence may corroborate the claim of the set of message data). Other methods of benefitting the content reliability score of the set of message data are also possible.

Consider the following example. A dynamic event in the form of an initial public offering (IPO) event for the international technology company Manoguac may be in progress. A first set of dynamic event data including live-blogs, images, and video footage for the IPO event may be captured by reporters and analysts in attendance at the IPO event. For instance, a set of dynamic event data including an image illustrating the IPO price for a share of Manoguac may be captured and ingested (e.g., via a picture taken by a reporter at the event). As an example, the image may indicate an IPO price of $26 dollars for one share of Manoguac. In embodiments, a set of message data (e.g., comment in a social networking environment) may be detected. For instance, the set of message data may include a claim from a chief market strategist at a financial services company that “Investors are very enthusiastic. Manoguac will certainly end the day at over $40 a share.” In embodiments, a second set of dynamic event data that includes a graph of the number of stock transactions and price paid for each share may be ingested. A set of inference data may be resolved from the second set of dynamic event data that indicates that, at the current rate of transaction, Manoguac will end the day at approximately $44 dollars a share. Accordingly, in embodiments, the set of inference data may be correlated with the set of message data from the chief market strategist (e.g., the transaction rate calculation may corroborate the prediction of the strategist). For instance, the social network comment of the chief market strategist may be augmented with the graph of the transaction rate to generate a corroborated message. Other methods of message management are also possible.

Method 200 concludes at block 299. As described herein, aspects of method 200 relate to dynamically (e.g., in real-time, ongoing, on-the-fly) correlating a set of inferences derived from a dynamic event with a user-generated message to compile a corroborated message related to the dynamic event. Aspects of method 200 may provide performance or efficiency benefits for content reliability. As an example, a set of inference data derived from a set of dynamic event data may be mapped to a set of message data related to the dynamic event to substantiate or corroborate the contents of the set of message data. Altogether, leveraging a set of inferences for a live event with respect to user-generated messages may be associated with content relevance, context awareness, and communication reliability.

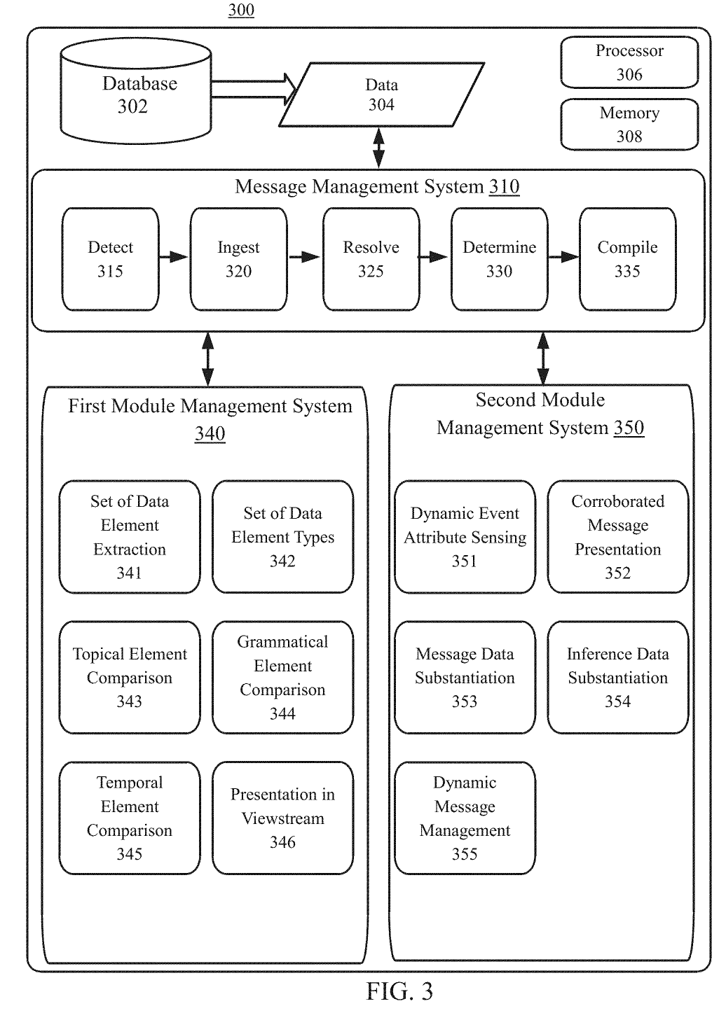

FIG. 3 shows an example system 300 for message management utilizing a social networking environment, according to embodiments. Aspects of FIG. 3 relate to dynamically (e.g., in real-time, ongoing, on-the-fly) correlating a set of inferences derived from a dynamic event with a user-generated message to compile a corroborated message related to the dynamic event. The example system 300 may include a processor 306 and a memory 308 to facilitate implementation of message management. The example system 300 may include a database 302 (e.g., message management database, dynamic event database, social networking database) configured to maintain data used for message management (e.g., dynamic event data, set of message data). In embodiments, the example system 300 may include a message management system 310. The message management system 310 may be communicatively connected to the database 302, and be configured to receive data 304 (e.g., set of message data, dynamic event data) related to message management. The message management system 310 may include a detecting module 315 to detect a set of message data in a social networking environment, an ingesting module 320 to ingest a set of dynamic event data related to a dynamic event, a resolving module 325 to resolve a set of inference data related to the dynamic event, a determining module 330 to determine corroboration relationship with respect to the set of message data and the set of inference data, and a compiling module 335 to compile a corroborated message related to the dynamic event. The message management system 310 may be communicatively connected with a first module management system 340 and a second module management system 350 that each include one or more modules for implementing aspects of message management.

In embodiments, a set of data elements may be extracted from the set of dynamic event data to resolve the set of inference data related to the dynamic event at module 341. Generally, extracting can include withdrawing, selecting, excerpting, extricating, identifying, or ascertaining the set of data elements. The set of data elements may include characteristics, portions, excerpts, properties, or other aspects of the set of dynamic event data. In embodiments, the set of data elements may include a natural language element (e.g., written text, word, phrase, speech, sign language), a topic (e.g., theme, subject), media (e.g., videos, images, audio recordings), a location (e.g., geographic position, place name) or the like at module 342. In embodiments, extracting may include utilizing one or more content analysis techniques (e.g., digital image analysis, natural language processing, semantic audio parsing) to identify and pull out the set of data elements from the dynamic event data. As an example, consider a set of dynamic event data including a video of a shareholder meeting presentation. Digital image analysis techniques may be used to identify information on presentation slides displayed in the video, and natural language processing techniques may subsequently be used to analyze and interpret the meaning of the information on the presentation slides (e.g., sales up by 24% year-over-year worldwide, significant sales potential is anticipated in developing markets). Other methods of extracting the set of data elements and other types of data elements are also possible.

In embodiments, a message topical element of the set of message data may be compared with an inferred topical element of the set of inference data at module 343. Generally, comparing can include contrasting, investigating, evaluating, analyzing, correlating, or otherwise examining the message topical element with respect to the inferred topical element. Aspects of the disclosure relate to the recognition that, in embodiments, correlating a message topical element of the set of message data with an inferred topical element of the set of inference data may have positive impacts with respect to context relevancy. In embodiments, the message topical element may include a theme, subject matter, or issue associated with the set of message data, and the inferred topical element may include a theme, subject matter, or issue associated with the set of inference data. In embodiments, comparing the message topical element with the inferred topical element may include utilizing a concept mapping technique to assess the similarity of the message topical element with respect to the inferred topical element. As an example, a message topical element of “Preparation for Long Distance Biking” identified from a social message comment may be examined with respect to an inferred topical element of “Tour across Europe,” for a set of dynamic event data and it may be determined that the two topical elements achieve a topic similarity threshold (e.g., substantially correspond). Accordingly, in embodiments the social message comment may be correlated with the set of dynamic event data. Other methods of comparing the message topical element of the set of message data with an inferred topical element of the set of inference data are also possible.

In embodiments, a message grammatical element of the set of message data may be compared with an inferred grammatical element of the set of inference data at module 344. Generally, comparing can include contrasting, investigating, evaluating, analyzing, correlating, or otherwise examining the message grammatical element with respect to the inferred grammatical element. Aspects of the disclosure relate to the recognition that, in embodiments, correlating a message grammatical element of the set of message data with an inferred grammatical element of the set of inference data may have positive impacts with respect to context relevancy. In embodiments, the message grammatical element may include a syntactic or semantic component of the set of message data, and the inferred grammatical element may include a syntactic or semantic component of the set of dynamic event data. As examples, the message grammatical element and the inferred grammatical element may include parts-of-speech, verb tenses, lexical categories, conjugations, punctuation, contractions, sentence types, and the like. In embodiments, comparing may include using a natural language processing technique to parse the message grammatical element and the inferred grammatical element and assess the similarity in grammatical structure. As an example, a message grammatical element of “singular” may be compared to an inferred grammatical element of “plural” tense, and it may be determined that the two do not achieve a threshold similarity level (e.g., a set of message data and a set of inference data that disagree on plurality may be related to different things). Other methods of comparing the message grammatical element with the inferred grammatical element are also possible.

In embodiments, a message temporal element of the set of message data may be compared with an inferred temporal element of the set of inference data at module 345. Generally, comparing can include contrasting, investigating, evaluating, analyzing, correlating, or otherwise examining the message temporal element with respect to the inferred temporal element. Aspects of the disclosure relate to the recognition that, in embodiments, correlating a message temporal element of the set of message data with an inferred temporal element of the set of inference data may have positive impacts with respect to context relevancy. In embodiments, the message temporal element and the inferred temporal element may include aspects that relate to time, sequential relations, duration, or other temporal characteristics. In embodiments, comparing may include contrasting a time and date associated with the set of message data with a time and date associated with the set of inference data. As an example, consider a set of message data with the text “Big earthquake in Japan” that is associated with a date and time of 7:29 AM May 16, 2010 as well as a set of inference data indicating a magnitude 6.1 earthquake in Japan that is associated with a date and time of 4:41 PM Sep. 6, 2015. The date and time of the set of message data may be compared with the date and time of the set of inference data, and it may be determined that they do not achieve a threshold similarity level (e.g., and it is thus likely that they refer to different events). Other methods of comparing the message temporal element of the set of message data and the inferred temporal element of the set of inference data are also possible.

In embodiments, the corroborated message may be presented in a viewstream in the social networking environment at module 346. The corroborated message may be presented without displaying the set of inference data. Generally, presenting can include displaying, exhibiting, conveying, or otherwise providing the corroborated message in the viewstream. The viewstream may include a timeline, live activity feed, or other interface including a stream of social media content. Aspects of the disclosure relate to the recognition that, in some situations, there may be spatial constraints associated with presenting the set of inference data together with the corroborated message in a social media viewstream (e.g., interfaces may be designed to prioritize a greater number of messages over message details; mobile screen size may not allow for media content coupled with every message). Accordingly, aspects of the disclosure relate to presenting the corroborated message in the viewstream without the set of inference data. In embodiments, presenting may include displaying a truncated view of the corroborated message, such that a first portion of the message (e.g., without the set of inference data) is shown in the viewstream, and a second portion of the message (e.g., the set of inference data) is displayed in response to activation from a user (e.g., clicking, touching). In embodiments, presenting may include marking the corroborated message in the viewstream with a validation tag to indicate that the message has been verified as authentic (e.g., corroborated message may be expanded to display the set of inference data in response to the command/instruction of a user). Other methods of presenting the corroborated message in a viewstream without displaying the set of inference data are also possible.

In embodiments, a search which indicates an attribute of the dynamic event may be sensed in the social network at module 351. Generally, sensing can include detecting, recognizing, sensing, identifying, or otherwise receiving the search which indicates an attribute of the dynamic event. The attribute may include a property, characteristic, component, or other aspect of the dynamic event. As an example, the attribute may include a keyword that pertains to the dynamic event. In embodiments, sensing the search which indicates an attribute of the dynamic event may include ascertaining that a user has initiated a query that substantially pertains to one or more aspects of the dynamic event (e.g., keyword included in the query corresponds with the dynamic event). In embodiments, in response to the search, the corroborated message using the set of inference data may be presented using the set of inference data at module 352. Generally, presenting can include displaying, exhibiting, conveying, or otherwise providing the corroborated message together with the set of inference data. In embodiments, presenting can include generating a list of candidate results including the corroborated message, and displaying them in response to the search query. Consider the following example. In response to sensing a search which includes a keyword (e.g., attribute) of “tennis,” a corroborated message including a set of message data of “National Open Winner Crowned!” and a link to a video replay of the finals may be presented (e.g., the keyword “tennis” may be associated with the event of “National Open”). Other methods of sensing a search which indicates an attribute of the dynamic event and presenting the corroborated message using the set of inference data are also possible.

In embodiments, the corroboration relationship may substantiate the set of message data by processing the set of inference data at module 353. As described herein, aspects of the disclosure relate to the recognition that providing a set of inference data (e.g., still image, video, audio recording or other media) may serve as evidence to substantiate or corroborate a set of message data. For instance, in embodiments, the veracity of a social media post may be validated using a televised video. Consider the following example. A set of message data may include a social media comment claiming that “Complete wooly mammoth skeleton found in Canada.” In embodiments, the social media comment may be tagged with a video to a televised press conference in which paleontologists confirm the discovery of the woolly mammoth, and present image and video evidence of their findings. Accordingly, as described herein, a corroboration relationship may be determined to substantiate the social media content using the televised press conference. Other methods of substantiating the set of message data using the set of inference data are also possible.

In embodiments, the corroboration relationship may substantiate the set of inference data by processing the set of message data at module 354. As described herein, aspects of the disclosure relate to the recognition that providing a set of message data (e.g., expert opinion, credible testimony, a social media message) may serve as evidence to substantiate or corroborate a set of inference data. For instance, in embodiments, the authenticity of a photograph posted on social media may be verified using the testimony of one of the individuals depicted in the photograph. Consider the following example. An individual who resembles famous movie star Lonny Shallows may appear in a photograph taken at a small-town bake sale. In embodiments, Lonny Shallows may submit a social media post of “What can I say. I love Mrs. Atkinson's lemon poppy seed muffins,” confirming his presence at the bake sale. Accordingly, as described herein, a corroboration relationship may be determined to substantiate the authenticity of the photograph using the social media post. Other methods of substantiating the set of inference data using the set of message data are also possible.

In embodiments, the detecting, the ingesting, the resolving, the determining, the compiling, and other steps described herein may each occur in a dynamic fashion to streamline message management at module 355. For instance, the detecting, the ingesting, the resolving, the determining, the compiling, and other steps described herein may occur in real-time, ongoing, or on-the-fly. As an example, one or more steps described herein may be performed simultaneously (e.g., set of message data may be detected at the same time that dynamic event data is ingested) in order to streamline (e.g., facilitate, promote, enhance) message management. Altogether, leveraging a set of inferences for a live event with respect to user-generated messages may be associated with content relevance, context awareness, and communication reliability.

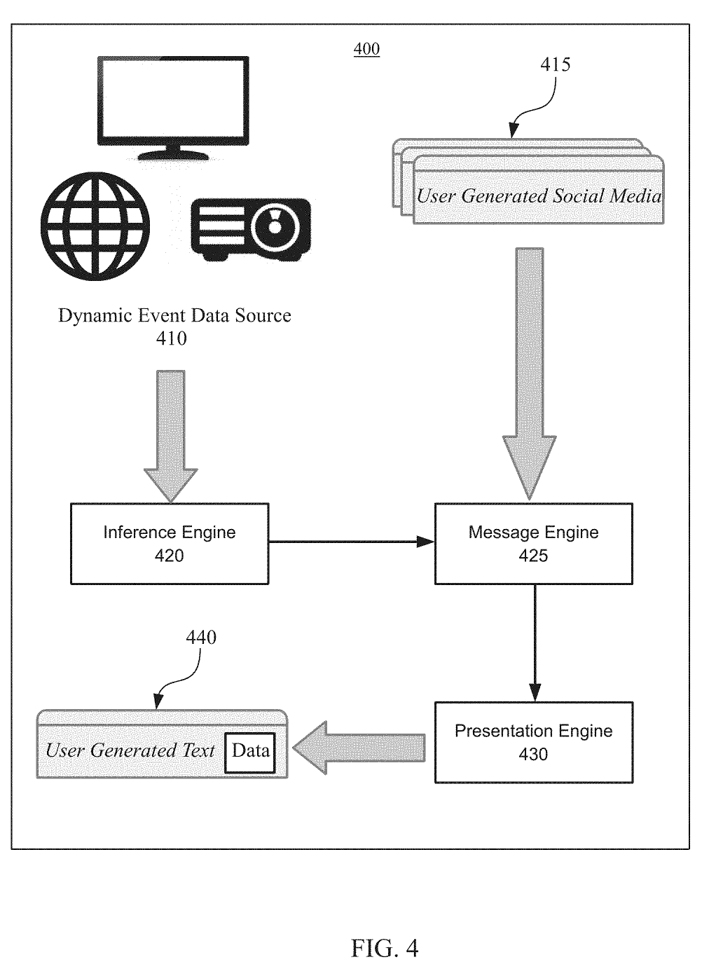

FIG. 4 shows an example architecture 400 for message management, according to embodiments. Aspects of FIG. 4 relate to using a set of dynamic event data related to a dynamic event together with user-generated social media content to compile a corroborated message. As shown in FIG. 4, the dynamic architecture 400 may include a dynamic event data source 410 (e.g., from which dynamic event data may be captured), a set of user-generated social media 415, an inference engine 420 for resolving a set of inferences based on the set of dynamic event data, a message engine 425 for compiling a corroborated message using the set of dynamic event data and the set of user-generated social media 415, and a presentation engine 430 for displaying/providing a corroborated message 440 using the set of inferences and the set of user-generated social media. As described herein, the message management architecture 400 is intended as an illustrative example, and other methods of message management are also possible.

In embodiments, the example architecture 400 may include a dynamic event data source 410. The dynamic event data source 410 may include a compliance or capture application program interface (API) configured to subscribe to one or more dynamic events (e.g., concerts, sporting events, news events) and collect a set of dynamic event data. For example, the dynamic event source 410 may include a capture API configured to collect the audio from a radio broadcast (e.g., of a sporting event) and use speech-to-text techniques to acquire time, date, and location data for the broadcast. As another example, the dynamic event data source 410 may include a capture API configured to capture the frames, closed-caption text around each frame (e.g., every 1 second, 2 seconds, 5 seconds) of a video, television, or live streaming broadcast. Other types of dynamic events sources including chat (e.g., instant messaging), web conferences, and the like are also possible.

In embodiments, the example architecture 400 may include an inference engine 420 configured to resolve a set of inferences for a dynamic event. The inference engine 420 may be configured to use natural language processing techniques to extract syntactic and semantic elements from the text. Object recognition techniques may be used to identify objects, information, actions, and locations present in videos, images, or other dynamic event information. The inference engine 420 may make use of the extracted natural language data and identified visual elements to generate inferences (e.g., observations, conclusions, deductions) for the dynamic event. In certain embodiments, the inferences may be expressed in natural language sentences. Other methods of resolving the set of inferences based on the dynamic event data are also possible.

In embodiments, the example architecture 400 may include a message engine 425 configured to receive a set of user-generated social media 415. As described herein, the set of user-generated social media 415 may include messages, posts, replies, picture/voice/video messages, or other content generated by users. The message engine 425 may be configured to detect one or more of a push event (e.g., content is published to a subscriber), pull event (e.g., content is continuously monitored for an updated entry added to an activity feed/data stream), or user interface event (e.g., new message creation or submission, draft or menu action activated via a user interface). In embodiments, the set of user-generated social media 415 may be captured using grip or compliance APIs. In response to receiving the set of user-generated social media 415, content including topics, grammar elements, specific mentions, or hashtags may be identified. As described herein, the set of user-generated social media 415 may be correlated with the set of inferences resolved by the inference engine 420. In embodiments, correlating may include matching the set of user-generated social media with the set of inferences using a similarity or relativity threshold assessed based on the topic, grammar elements, time, and location of the set of user-generated social media 415 and the set of inferences.

In embodiments, the example architecture 400 may include a presentation engine 430 configured to compile a corroborated message 440. In embodiments, compiling may include augmenting the set of user-generated social media 415 with one or more inferences of the set of inferences. For instance, in embodiments, the corroborated message 440 may include a composite communication including an original message from a user together with a link, image, video, comment, or other aspect of the set of inferences. As an example, the corroborated message 440 may include an original social media comment made by a user regarding a concert together with a video of the concert. Other types of corroborated message 440 are also possible.

Consider the following example. A dynamic event in the form of a debate may be in progress. A set of dynamic event data including audio/video footage (e.g., television broadcast) as well as textual data (e.g., officially published transcript) of the debate may be collected. In the debate, one participant may make a set of policy proposals that relate to subsidizing cane sugar. In response to the policy proposal of the participant, viewers of the debate may submit social network messages attempting to interpret the meaning and implications of the proposal (e.g., “Does this indicate that ‘beet sugar’ is not included in the subsidy?” “Did the participant mean a large-scale agricultural subsidy that includes cane sugar?”). In embodiments, as described herein, aspects of the disclosure relate to resolving a set of inference data related to the debate. For instance, the set of inference data may include a video clip of the debate that includes the portion pertaining to the cane sugar subsidy. As another example, the set of inference data may include a deduction that, as the debate took place in a state with a large cane sugar production industry, the mention of cane sugar may have been made specifically to appeal to residents/voters of that state. In embodiments, a set of message data from a policy analyst may be detected that reinforces the idea that cane sugar was specifically mentioned to appeal to a particular demographic, and that the cane sugar subsidy is likely part of a larger agricultural subsidy. As described herein, the set of message data from the policy analyst may be correlated with the set of inference data to generate a corroborated message (e.g., the statement of the policy analyst may substantiate the inference). Other methods of message management are also possible.

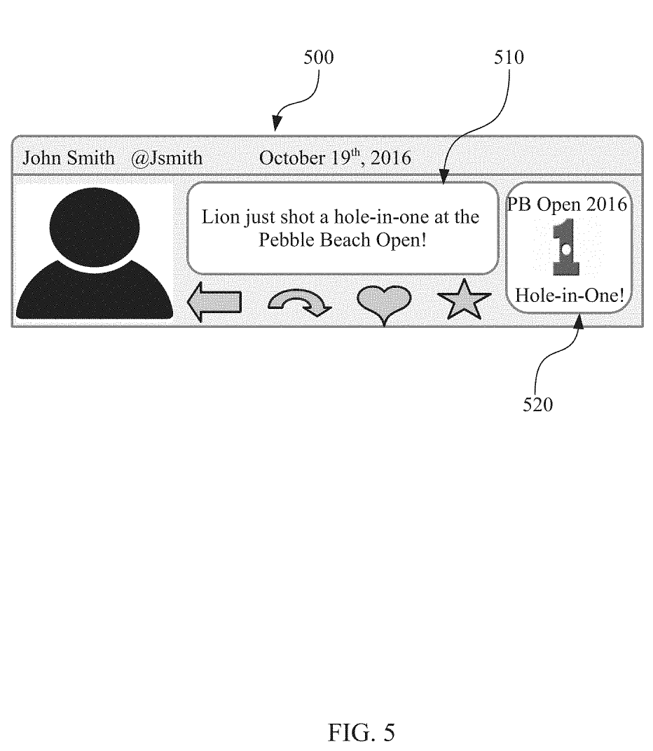

FIG. 5 illustrates an example corroborated message 500, according to embodiments. Aspects of FIG. 5 relate to compiling a corroborated message 500 using a set of inference data and a set of message data. As described herein, the corroborated message 500 may include a set of message data 510 (e.g., social media post, reply, comment) that has been augmented to include a set of inference data 520 (e.g., image, link, video clip, or other data to authenticate, validate, or substantiate the set of message data) resolved using a set of dynamic event data related to a dynamic event.

Consider the following example. A golf tournament series may be held each year with tournaments in a number of cities. For instance, as part of the tournament series, a golf competition (e.g., dynamic event) called the “Rocky Beach Open 2016” may be held and attended by a number of professional golfers. As described herein, dynamic event data including television broadcasts and Internet-based live-streams may be captured for the golf competition. In embodiments, the famous golfer Lion Groves may achieve a hole-in-one shot to win the tournament, duplicating the feat that he first performed at the same tournament two years earlier (e.g., Rocky Beach Open 2014). An onlooker in attendance at the tournament may submit a set of message data 510 including a social media post stating that Lion shot a hole-in-one at the Rocky Beach Open. In embodiments, as described herein, the set of dynamic event data for the golf competition may be analyzed, and a set of inferences 520 may be resolved. For instance, the set of inferences 520 may include a video clip showing the hole-in-one achieved by Lion Groves. As described herein, aspects of the disclosure relate to compiling a corroborated message 500 using both the set of message data 510 and the set of inferences 520. The set of message data 510 and the set of inferences 520 may be compared, and it may be determined that both the set of message data 510 and the set of inferences 520 achieve a similarity threshold. Accordingly, the video clip of the hole-in-one may be appended to the set of message data 510 to compile the corroborated message 500. In this way, the set of message data 510 may be corroborated by the video clip (e.g., and confusion regarding the distinction between the Rocky Beach Open 2014 hole-in-one and the Rocky Beach Open 2015 hole-in-one may be avoided). Other methods of compiling the corroborated message 500 are also possible.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used, and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

What is claimed is:

1. A computer-implemented method for message management utilizing a social networking environment, the method comprising:
detecting, in the social networking environment, a set of message data;
monitoring a set of dynamic event data related to a dynamic event;
ingesting the set of dynamic event data related to the dynamic event, wherein the set of dynamic event data is selected from a group consisting of: audio data, video data, still image data, textual data, chat data, web conference data, and streaming data;
capturing a set of data objects using the set of dynamic event data related to the dynamic event;
resolving, using the set of dynamic event data related to the dynamic event, a set of inference data related to the dynamic event, wherein resolving the set of inference data related to the dynamic event comprises:
analyzing, to resolve the set of inference data related to the dynamic event, the set of data objects;
extracting, from the set of dynamic event data to resolve the set of inference data related to the dynamic event, a set of data elements, wherein the set of data elements includes: a natural language, a topic, media, and a location;
determining, by correlating the set of message data with the set of inference data, a corroboration relationship with respect to the set of message data and the set of inference data, wherein determining the corroboration relationship with respect to the set of message data and the set of inference data comprises:
comparing a message topical element of the set of message data with an inferred topical element of the set of inference data;
comparing a message grammatical element of the set of message data with an inferred grammatical element of the set of inference data; and.
comparing a message temporal element of the set of message data with an inferred temporal element of the set of inference data;
compiling, based on the corroboration relationship with respect to the set of message data and the set of inference data, a corroborated message related to the dynamic event; and
presenting, in a viewstream in the social networking environment, the corroborated message without displaying the set of inference data.
